(19) United States
(12) Patent Application Publication
(10) Pub. No.: US 2003/0088762 A1
(43) Pub. Date: May 8, 2003

(54) Storage media of operating system arranging at the expansion slot of motherboard

(76) Inventors: Jenny Liang, Hsinchu City (TW); David Hsu, Jeu-Dong Town (TW)

Correspondence Address: RABIN & BERDO, P.C., Suite 500, 1101 14th Street, N.W., Washington, DC, 20005, US

(21) Appl. No.: 09/985,577

(22) Filed: Nov. 5, 2001

(51) Int. Cl. G06F 15/177; G06F 12/00

(52) U.S. Cl. 713/1; 711/100

(57) ABSTRACT

The present invention relates to a kind of storage media of operating system arranging at the expansion slot of motherboard, herein according the basic input/output system, BIOS, of operating system in the computer to install said system in the storage media. Since every starting of the computer, the storage media will grant a domination right to start the computer. Then, via the bus on the expansion slot of the master board, the storage media will load the memory in and execute said operating system.

### TECHNICAL FIELD

The present invention provides a kind of storage media of operating system arranging at the expansion slot of motherboard, especially which can facilitate a great reliability of operating system and can achieve this design of demand that said operating system and the general data will be installed in different media.

### BACKGROUND OF THE PRESENT INVENTION

Shown as FIG. 1, since starting the computer of POST (Power-On Self Test) to execute BIOS, the domination rights of said computer will be transferred to the operating system. Accordingly, the operating system served in a conventional computer is installed in the hard disk (10) or the media which are compatible to the hard disk. Then, the CPU (11) will instruct the chip set (12) an executive command to dominate the needing data that accessed through the hard disk controller (13) to hard disk ( 10) or media which are compatible to the hard disk. These data will be transferred onto the memory (14) via the PCI bus (30), then the CPU will read said data from the memory (14) and execute commands, both said data and commands will be delivered via AGP (Accelerated Graphics Port) bus (50) then displayed the picture of operating system on the screen of the computer. Accordingly, the operating system and application software will follow this routine to load in and execute. As the computer virus invades into and infects the computer, mostly the software program which installed in the hard disk (10) may be destroyed. Moreover, aforementioned data and commands will not normally be loaded into and executed by the hard disk (10) that leads to the computer is unable to be started ongoing its normal operation. So the computer user has to reinstall or formalize the hard disk which should trouble the user greatly. Furthermore, speeds to reinstall and format the hard disk (10) is far slower than the execution speeds of the CPU, thus said user must take much longer period to start the computer.

The buses of PCI (Peripheral Component Interconnect) and ISA (Industry Standard Architecture) are been widely applied to computer system nowadays, mostly, one or more slots have been provided in every of PC, workstation and industrial computer for supplying the user to extend a various usage of said computing device maximally. So the designer of the motherboard, usually, should reserve one or more slots on the motherboard.

### SUMMARY OF THE PRESENT INVENTION

Accordingly, an object of the present invention is to store the operating system in the media of an expansion card, and via proprietary boot loader, which follows the specification of expansion card's BIOS (Basic input/output System) as an expansion card's BIOS. The motherboard only sights the expansion BIOS. When the motherboard BIOS starts initializing, the BIOS of the expansion card will have chance to do its initialization and then will get a domination right when the system starts booting up.

Another object of the present invention is that the operating system is loaded by firmware. The virus can not destroy the operating system which can facilitate the reliability of operating system's installing and widen the storage space of hard disk.

The structural design and technical method of the present invention will be detail described and explained, also accompanied with drawings for further referring and understanding its features as follows.

### DESCRIPTION OF DRAWINGS

FIG. 1, a block diagram of operation system of the presented computer

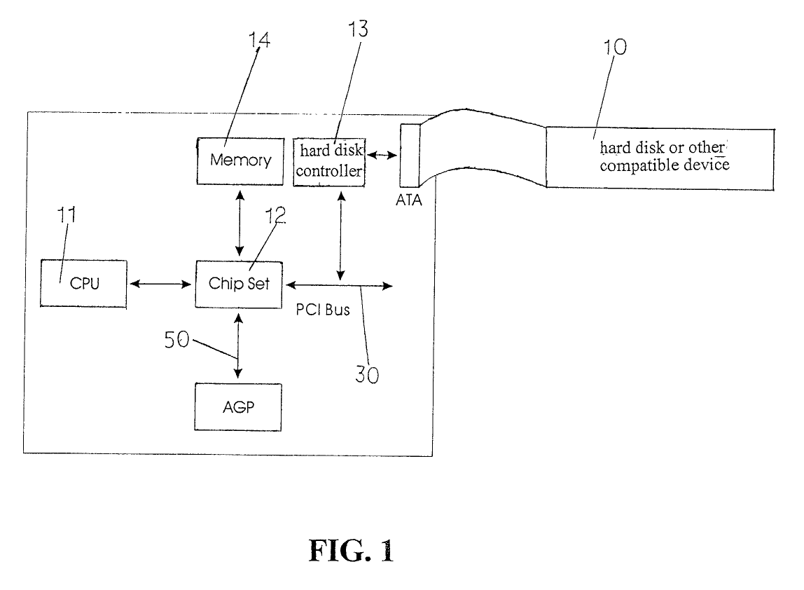

FIG. 2, a bock diagram of the first practical example of the present invention.

FIG. 3, a bock diagram of the second practical example of the present invention

FIG. 4. a bock diagram of the third practical example of the present invention

### DESCRIPTION OF TERMS

10 hard disk or other compatible device

11 CPU

12 host-PCI bridge wafer

13 hard disk controller

14 memory

20 expansion card

30 PCI bus

40 ISA bus

41 communication protocol

50 AGP port

### DETAILED DESCRIPTION OF THE PRESENT INVENTION

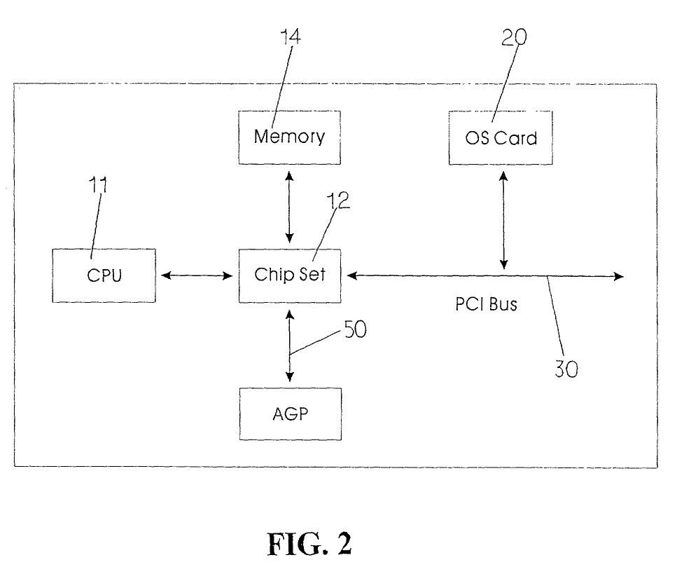

Please refer to FIG. 2, shown the present invention as a boot loader of operation system or entire operation system which is collocated in the storage media of expansion card (20). The expansion card (20) is a bootable device and is able to adapted to the proprietary bootable loader, herein said boot loader will refer to said system versus of expansion card's (20) BIOS, and boot loader is altered to fit into the specification of expansion card's (20) BIOS. In the beginning period of computer starting, the motherboard will find the BIOS of expansion card (20), then the motherboard will begin its initialization, and the BIOS of expansion card will access an opportunity to initialize and to respond this data to the system. This result makes the system opt the expansion card (20) to start the computer or makes the expansion card get the boot control. Then the boot loader of operating system will via the storage media of expansion card (20)—which been installed the operating system—and through the PCI bus (30) to load said operation system into the memory (14) of said system and to begin an executive demand onto said system.

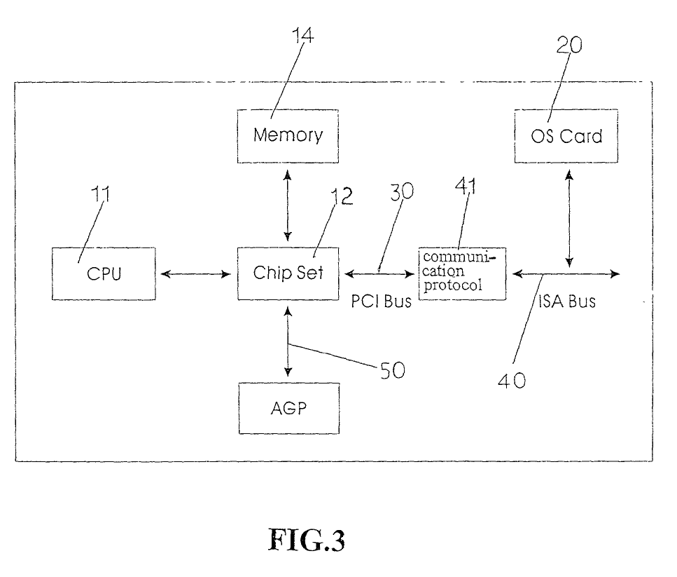

FIG. 3 shown as the present invention utilizes ISA bus (40) to load in the operating system. Presently, for PCI bus (30) is adapted for using in the chip set (12) to account of its peripheral devices that makes the bus (40) have to via communication protocol (41), then transfer into the model of PCI (bus).

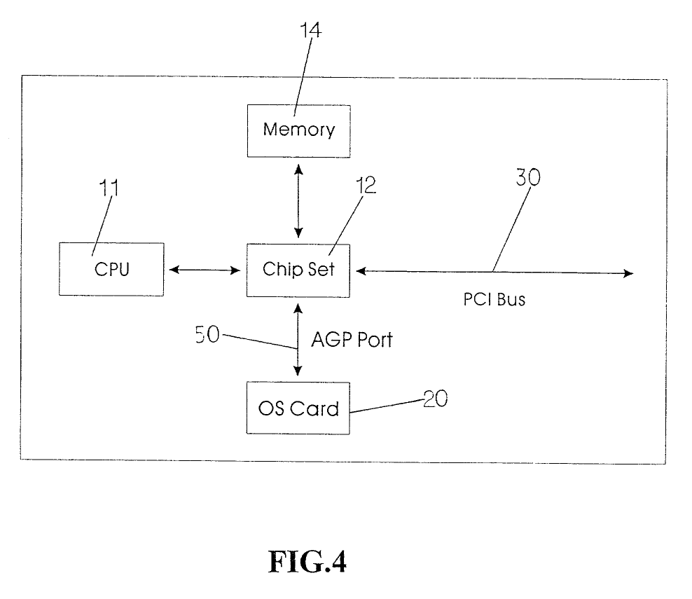

FIG. 4 shown as the present invention utilizes AGP bus (50) to load in the operation system.

Accordingly, the present invention utilizes the presented bus or buses as the path for data loading. Of course, any of tomorrow bus or buses under the protocol which will be very available for merely altering the BIOS of expansion card, meanwhile, the present invention is not only for extending to the model(s) of expansion card but also for directly instructing onto the motherboard by this hard disk model to load in the operating system via bus. Thus the present invention will shorten the computer's staring timing and promote the operating system's reliability to prevent the hard disk which is destroyed by virus and is unavailable to start the computer.

Summarizing the aforementioned, the present invention provides the storage media of operating system arranging at the expansion slot of motherboard, which has really the practical applicability, the creativeness and advance that confirms to the regulations specified in the Patent Law.

While the present invention herein disclosed has been described by means of specific embodiments and applications thereof, numerous modifications and variations could be made thereto by those skilled in the art without departing from the scope of the present invention set forth in the claims.

What is claimed is

1. Method for storage media of operating system arranging at the expansion slot of motherboard, mainly by means of installed the boot loader of operation system or entire operation system in the storage media of a expansion card, herein the expansion card will be initialized and granted the operation system's domination rights while a computer is been stared, and said installed operation system will via bus and will be loaded into the memory of operation system to start executing commands onto the operation system.

2. According to claim 1, method for storage media of operating system arranging at the expansion slot of motherboard, consisting a boot loader program of said operation system, herein said boot loader program is to alter the specification of expansion card's BIOS—according to and referring to said operation system's alteration—into the BIOS of expansion card for a priority selection falling on said operation system to start the computer by expansion card.

3. According to claim 1, method for storage media of operating system arranging at the expansion slot of motherboard, herein the buses including ISA [symbol] PCI [symbol] AGP, of their specifications can be loaded as the bus of expansion card's BIOS.
